(19) United States
(12) Patent Application Publication
(10) Pub. No.: US 2026/0271150 A1
(43) Pub. Date: Sep. 10, 2026

(54) A CONTROLLER FOR CONTROLLING A LINEAR LIGHT SOURCE ARRAY

(71) Applicant: SIGNIFY HOLDING B.V., EINDHOVEN (NL)

(72) Inventors: TIES VAN BOMMEL, HORST (NL); JEROEN KLEEVEN, HORST (NL)

(21) Appl. No.: 19/164,680

(22) PCT Filed: Mar. 11, 2024
(86) PCT No.: PCT/EP2024/056343

§ 371 Date: Sep. 12, 2025

(30) Foreign Application Priority Data
Mar. 16, 2023 (EP) 23162402.4

(51) Int. Cl. H05B 45/20; F21S 4/28; F21Y 115/10; H05B 45/10; H05B 47/155; H05B 47/165

(52) U.S. Cl. CPC H05B 45/20; F21S 4/28; H05B 45/10; H05B 47/155; H05B 47/165; F21Y 2115/10

(57) ABSTRACT

The invention relates to a controller (1) for controlling decorative lighting effect. A controller (1) controls a linear light source array (20) comprising a plurality of LED light sources (21-26) according to a first gradient light scene and a second gradient light scene. A first gradient light high low scene is capable of defining different first color points (11, 12) for said plurality of LED light sources (21-26) during use, such that the plurality of LED light sources provides a first illumination at a predefined distance. A second gradient light scene different from said first gradient light scene is capable of defining different second color points (11, 12) for said plurality of LED light sources (21-26) during use, such that the plurality of LED light sources (21 -26) provides a second illumination at the predefined distance. The controller is furthermore configured to select the second gradient light scene, such that during a first transitioning from the first gradient light scene to the second gradient light scene, a correlated color temperature, CCT, of a perceived illumination at the predefined distance is kept constant, or a correlated color temperature, CCT, of a perceived illumination at the predefined distance increases or decreases.

### FIELD OF THE INVENTION

The invention relates to a controller for controlling a linear light source array.

### BACKGROUND OF THE INVENTION

A gradient light device is based on a linear light source array, wherein the light from the linear light source array may shine in a direction and create a surround lighting as an accompaniment for a multimedia device. When a gradient light device is turned on, the light offers a choice of ambient lighting, such as a white light or a gradient of colorful light that, may reacts to the content on multimedia device.

US 2020294466 A1 relates to controlling diodes and producing colored light displays. It discloses controlling one or more diodes individually capable of producing multiple colors of light and producing various colors of light in said diodes. In some embodiments, a color control software instructs a set of diodes to produce smooth gradients be-tween adjacent colors in a color sequence. In additional embodiments, a color control system instructs the set of diodes to display smooth transitions between color sequences.

U.S. Pat. No. 8,928,249 B2 discloses a system providing white light having a selectable spectral characteristic (e.g. a selectable color temperature, delta UV, and intensity) using a combination of sources (e.g. LEDs) emitting light of three, four, five, or six different characteristics, for example, one or more white LEDs, and one or more LEDs of each of three primary colors, plus cyan and royal blue. A controller maintains a desired spectral characteristic, e.g. for white light at a selected point on or within a desired range of the black body curve. In addition, the controller provides selectable adjustments for values of the spectral characteristics, while maintaining substantially constant overall output intensity for the light output of White LEDs, thereby achieving Maximum Utilization.

However, there is still a desire to provide an improvement in the decorative lighting effect and light quality when using linear light source array or a luminaire comprising linear light source array.

### SUMMARY OF THE INVENTION

It is an object of the present invention to provide an improvement in the decorative lighting effect and light quality when using linear light source array or a luminaire comprising linear light source array.

The object of the present invention is furthermore to improve a user's perception of the lighting at a predefined distance as an accompaniment for a multimedia device or similar.

These and other objects are achieved by providing a controller for controlling a linear light source array, wherein the linear light source array comprises a plurality of LED light sources configured to, in operation and in combination, provide an array light having a total luminous flux providing a (perceived) illumination at a predefined distance, wherein the controller is configured to control the plurality of LED light sources according to:
a first gradient light scene, where the first gradient light scene defines at least five first color points, such that the plurality of LED light sources provides a first illumination at the predefined distance,
a first transitioning from the first gradient light scene to a second gradient light scene different from the first gradient light scene, where the second gradient light scene defines at least five second color points different from each other, wherein at least one of the at least five second color points are different than at least one of the at least five first color points, such that the plurality of LED light sources provides a second illumination at the predefined distance,
wherein the controller is configured to select the second gradient light scene, such that during the first transitioning from the first gradient light scene to the second gradient light scene,
(i) a correlated color temperature, CCT, of the (perceived) illumination at the predefined distance is kept constant, or
(ii) the correlated color temperature, CCT, of the (perceived) illumination at the predefined distance increases or decreases.

The controller is configured to control one or more linear light source array to provide a (perceived) illumination at the predefined distance from the linear light source array.

The (perceived) illumination may be measured at the predefined distance of at least 1.5 m, alternative at least 2 m or 2,5 m, from the linear light source array. The illumination may be a target illumination. A linear light source array comprises a plurality of LED light sources which is controlled by the controller. The linear light source array comprises a plurality of LED light sources configured to provide an array light having a total luminous flux. The plurality of LED light sources may comprise at least five light LED light sources in a linear light source array. Preferably, the plurality of LED light sources may comprise at least ten LED light sources in a linear light source array. More preferably the plurality of LED light sources may comprise at least fifteen LED light sources in a linear light source array. Most preferably, the plurality of LED light sources may comprise at least twenty LED light sources in a linear light source array. The controller is configured to provide a (perceived) illumination on surrounding surfaces at the predefined distance from the linear light source array. During use the linear light source array is configured to emit light from the plurality of LED light sources. The controller is configured to simultaneously or individually control the plurality of LED light sources to provide an array light. The light emitted from the linear light source array is provided according to different light scenes, which enhances a user's experience of an event. The light scene are the array light settings, which refers to the total additive mix of light along the linear light source array when emitted from the LED light sources. The light scenes are also referred to as gradient light scenes.

Each of the light color points are light emitted from the linear light source array, wherein the light color points along the linear light source array are mixed, such that the total array light emitted provides intermediate light along the linear light source array. The linear light source array provides a (perceived) illumination, e.g., a predetermined light scene, at the predefined distance from the linear light source array. The array light may form a light pattern along the linear light source array defined by the intermediate light points generated from the light color points.

In specific embodiments, the light color points may be different when the respective color points differ with at least 0.01 for u′ and/or with at least 0.01 for v′, wherein u′ and v′ are color coordinate of the light in the CIE 1976 UCS, uniform chromaticity scale diagram. The light color points is even more different, when the respective color points differ with at least 0.02 for u′ and/or with at least 0.02 for v′. In yet more specific embodiments, when the respective color points differ with at least 0.03 for u′ and/or with at least 0.03 for v′.

One or more linear light source arrays may be arranged on a flexible PCB and/or in a flexible tube or similar in a predetermined length. The linear light source array or arrays may extend linearly in one direction or may extend in more directions when for example being bend accordingly along an edge of a multimedia device.

The controller is configured to control a plurality of LED light sources comprised in the linear light source array according to a gradient light scene. The controller is configured to control each of the plurality of LED light sources and/or sections of the plurality of LED light sources according to the gradient light scene. A first gradient light scene defines different first color points for each of the plurality of LED light sources and/or sections of the plurality of LED light sources during use, such that the plurality of LED light sources provides a first illumination at a predefined distance along the linear light source.

The controller is also configured to control each of the plurality of LED light sources and/or sections of the plurality of LED light sources according to a second gradient light scene different to the first gradient light scene. The second gradient light scene defines different second color points for each of the plurality of LED light sources and/or sections of the plurality of LED light sources during use, such that the plurality of LED light sources provides a second illumination at a predefined distance along the linear light source array.

The controller is furthermore configured to control the plurality of LED light sources comprised in the linear light source array, such that the gradient light scene is varied from the first gradient light scene to a second gradient light scene via the first transitioning. The controller is configured to select the second gradient light scene such that during the first transitioning from the first gradient light scene to the second gradient light scene a CCT of a (perceived) illumination at the predefined distance is kept constant.

Alternatively, the controller is configured to select the second gradient light scene such that, during the first transitioning from the first gradient light scene to the second gradient light scene a CCT of a (perceived) illumination at the predefined distance increases or decreases. Thereby, and in particular by the controller being configured to select the second gradient light scene according to either of the two above-described alternatives.

The present invention provides an improvement in the decorative lighting effect and light quality when using linear light source array or a luminaire comprising linear light source array, such that a user's perception of the lighting at the predefined distance from the linear light source array is enhanced.

In an embodiment, the controller is configured to control the array light from the linear light source array, such that when the CCT of the (perceived) illumination at the predefined distance increases or decreases, the CCT of the (perceived) illumination at the predefined distance follows the Black Body Locus, BBL from a first CCT to a second CCT, wherein a gradient step between the first CCT and the second CCT is equal to or more than 300 K or is equal to or more than 500K.

The CCT of the (perceived) illumination at the predefined distance may follow the Black Body Locus, BBL, linearly or curved according to the BBL, and preferably within 10 SDCM from the BBL.

The controller is configured to control the array light from the linear light source array, which emits from the LED light sources arranged in the linear light source array. The controller may be configured to select the second gradient light scene such that, during the first transitioning from the first gradient light scene to the second gradient light scene a CCT of a (perceived) illumination at the predefined distance increases or decreases. The controller may be configured to control the light emitting from the plurality of LED light sources according to color points defined by the gradient light scene, such that the CCT of the (perceived) illumination follows the BBL. The controller may be configured to control the array light from the linear light source array, such that when the CCT of a (perceived) illumination at the predefined distance increases or decreases, the CCT of the (perceived) illumination at the predefined distance follows the Black Body Locus, BBL, from a first CCT to a second CCT. A gradient step between the first CCT and the second CCT may be equal to or more than 500K, wherein K refers to Kelvin degrees. Preferably the gradient step between the first CCT and the second CCT may be equal to or more than 1000K. More preferably the gradient step between the first CCT and the second CCT may be equal to or more than 1500K. Most preferably the gradient step between the first CCT and the second CCT may be equal to or more than 2000K.

An Example may be that the first CCT may be equal to or less than 2700K and/or second CCT may be equal to or more than 3000K. Alternatively the second CCT may be equal to or less than 2700K and/or first CCT may be equal to or less more 3000K. During transitioning the CCT may preferably be transitioned in a linearity line between the two color points arranged substantially on or relatively to the BBL. Preferably, the CCT may preferably be transitioned in a curved line between the two color points arranged substantially on or relatively to the BBL. Preferably within 10 SDCM, Standard Deviation of Color Matching, from the BBL. More preferably within 5 SDCM from the BBL.

The gradient light scene may be defined by a user or by a predetermined gradient light scene sequence. The user may provide an input to the controller determining the first gradient light scene. The controller controls the plurality of LED light sources according to the choice of first gradient light scene. The controller controls the different first color points for the plurality of LED light sources, such that the plurality of LED light sources provides a first illumination at a predefined distance based on the user's input. The following gradient light scenes may be selected relative to the first gradient light scene.

The first gradient light scene defines at least five first color points, such that the plurality of LED light sources provides a first illumination at the predefined distance. Preferably, the first gradient light scene defines at least five first color points. More preferable, the first gradient light scene defines at least eight first color points. Most preferable the first gradient light scene defines at least ten first color points. The first transitioning from the first gradient light scene to a second gradient light scene different from the first gradient light scene. The second gradient light scene defines at least five second color points different from each other, wherein at least one of the at least five second color points are different than at least one of the at least five first color points, such that the plurality of LED light sources provides a second illumination at the predefined distance. Preferably at least 5 second color points, more preferably at least 8 second color points, most preferably at least 10 second color points different from each other.

One or more of the first color points of the first gradient light scene is different from the second color points of the second gradient light scene. The first gradient light scene and the second gradient light scene are part of a dynamic gradient light scene, where for example the gradient light scene is varied from the first gradient light scene to a second gradient light scene via a first transitioning. Alternative, the gradient light scene is varied from the first gradient light scene via a second gradient light scene to a third gradient light scene etc., using further transitioning. The transitioning between different gradient light scene may for example be based on a constant changing control sequence or a random changing control sequence.

In an embodiment said controller is configured to control the array light from the linear light source array, wherein the plurality of LED light sources arranged on the linear light source array are configured to:
(i) increase the total luminous flux of the array light, when the CCT of the (perceived) illumination at the predefined distance increases, and/or
(ii) decrease the total luminous flux of the array light, when the CCT of the (perceived) illumination at the predefined distance decreases.

When the CCT of the (perceived) illumination at the predefined distance is increased, the controller may control the linear light source array during use, such that the luminous flux emitting from the LED light sources also is increased. When the CCT of the (perceived) illumination at the predefined distance is decreased, the controller may control the linear light source array such that the luminous flux emitting from the LED light sources also may be decreased. The luminous flux emitting from the LED light sources may be dependent on the current CCT of the (perceived) illumination at the predefined distance.

In an embodiment said controller is configured to control the plurality of LED light sources, wherein the plurality of LED light sources are configured to emit the array light, such that the (perceived) illumination at the predefined distance is according to the first gradient light scene, wherein the first gradient light scene comprises a sequence of at least five different light color points, such that the at least five different color points have respective CCTs.

The controller may control the plurality of LED light sources according to in the linear light source array, such that the array light emitted from the plurality of LED light sources defines the first gradient light scene. The first gradient light scene comprises a sequence of at least five different light color points, wherein the at least five different color points have each respective CCTs, for example the first CCT is has a lower CCT compared to the other CCTs in the sequence, and the fifth CCT has the highest CCT compared to the other CCTs in the sequence. The at least five different light color points may be defined by the at least five different respective gradient stop. The at least five different color points increases from a first color point of the sequence to a last color point of the sequence. More preferably, at least eight different color point increases from a first color point of the sequence to a last color point of the sequence. Most preferably at least ten different color points increases from a first color point of the sequence to a last color point of the sequence. For example, the sequence may start at the first color point at 3000K, then according to the sequence, defined by the first gradient light scene, increases the intermediated gradient stop from the first color point 3000K to the second color point 3300K, and further from the second color point 3300K to the third color point 3600K etc. The differences in CCT between neighboring color points may be a gradient step of at least 300K.

In an embodiment said controller is configured to control the plurality of LED light sources, wherein the plurality of LED light sources are configured to emit the array light, such that the (perceived) illumination at the predefined distance is according the second gradient light scene:
(i) in that the second gradient light scene defines that at least one of the at least five light color points CCT are increased, such that the CCT of the (perceived) illumination at the predefined distance is increased,
(ii) in that the second gradient light scene defines that at least one of the at least five light color points CCT are decreased, such that the CCT of the (perceived) illumination at the predefined distance is increased.

The controller may be configured to control the plurality of LED light sources according to performance of the second gradient light scene relative to the first gradient light scene. The first gradient light scene comprises sequence of at least five different light color points. More preferably, the first gradient light scene comprises sequence of at least eight different light color points. Most preferably, the first gradient light scene comprises sequence of at least ten different light color points. The different color points have each respective CCTs, which increases from the first CCT, which has the lowest CCT compared to the other CCTs in the sequence, increasing to the fifth CCT has the highest CCT compared to the other CCTs in the sequence. In the second gradient light scene at least one of the light color points CCT may be increased, such that the CCT of a (perceived) illumination at the predefined distance is increased. Alternative, in the second gradient light scene at least one of the light color points CCT may be decreased, such that the CCT of a (perceived) illumination at the predefined distance is increased. The gradient step or steps from a first gradient light scene to a second gradient light scene cause a variation in CCT in the far field of the illumination at the predefined distance.

In an embodiment said controller is configured to control the plurality of LED light sources, wherein:
(i) one or more of the plurality of LED light sources are arranged at a first end of the linear light source array, wherein the one or more of the plurality of LED are configured to correspond to one or more color points with the highest CCT compared to the one or more of the plurality of LED light sources, which are arranged at a first end of the linear light source array, when dimmed down or switched off, and/or
(ii) one or more of the plurality of LED light sources are arranged at a second end of the linear light source array, wherein the one or more of the plurality of LED are configured to correspond to one or more color points with the lowest CCT compared to the one or more of the plurality of LED light sources, which are arranged at a first end of the linear light source array, when dimmed down or switched off.

The linear light source array comprises a plurality of LED light sources. One or more of the pluralities of LED light sources may be arranged at a first end of the linear light source array. One or more of the pluralities of LED light sources may be arranged at a second end of the linear light source array, wherein the LED light sources are different to the LED light sources in the first end of the linear light source array. At least one of the pluralities of LED light sources arranged in the first end of the linear light source array are configured to correspond to one or more color points with the highest CCT, when dimmed down or switched off. At least one of the pluralities of LED light sources arranged in the second end of the linear light source array are configured to correspond to one or more color points with the lowest CCT, when dimmed down or switched off. At least one of the pluralities of LED light sources arranged in each end of the array may be configured to correspond to one or more color points with the different CCTs. The CCT of the pluralities of LED arranged in the first or the second end of the array will correlate, which can be observed at the illumination at the predefined distance. This causes the CCT in the far field to vary relative to the CCT, such that when the CCT is high, the CCT in the far field may be lower the high CCT, and vice versa. In one example, the lowest CCT may be in a first gradient light scene may be at most 2700K, or at most 2500K. in another example the highest CCT may be in a first gradient light scene may be at most 3000K, or at most 3500K.

In an embodiment the controller is further configured to control the plurality of LED light sources, such that during a second transitioning from the second gradient light scene to the first gradient light scene, and during a third transitioning from the second gradient light scene to a third gradient light scene different from said second gradient light scene,
(i) the CCT of the (perceived) illumination at the predefined distance is kept constant, or
(ii) the CCT of the (perceived) illumination at the predefined distance increases or decreases.

The controller is configured to control each of the plurality of light sources or sections of the plurality of LED light sources. By the term section of the plurality of LED light sources is intended to be meant two or more neighboring LED light sources of the plurality of LED light sources. the controller is further configured to control the plurality of LED light sources, such that the plurality of LED light sources provide a second transitioning from the second gradient light scene to the first gradient light scene, and during a third transitioning from the second gradient light scene to a third gradient light scene different from said second gradient light scene etc. The controller controls the performing of the transitioning from the second gradient light scene back to the first light scene, which is opposite the first transitioning. The controller controls the second transitioning from the second gradient light scene back to the first light scene, such that during the transition the CCT of the (perceived) illumination at the predefined distance is kept constant. Alternatively, the controller controls the second transitioning from the second gradient light scene back to the first light scene, such that during the transition from the CCT of the (perceived) illumination at the predefined distance increases or decreases. The controller may control a third transitioning from the second gradient light scene to a third gradient light scene different from said second gradient light scene, such that the CCT of a (perceived) illumination at the predefined distance is kept constant, or the CCT of the (perceived) illumination at the predefined distance increases or decreases.

In an embodiment at least two gradient end stops are defined by the selected color points, where each of the selected color points each represent a respective dominant peak wavelength different from the remaining respective dominant peak wavelengths, wherein the controller is configured to control the plurality of LED light sources, such that the light emitting from the plurality of LED light sources vary each of the at least two gradient end stops independently, when varying the selected color points.

A gradient light scene is defined by the plurality of LED light sources, which provides at least two gradient end stop comprising respective color points which is selected according to a predetermined gradient light scene. Each of the color points are related to the respective gradient end stop, wherein the color points are provided by the LED light sources or the sections of LED light sources. The controller is configured to vary each of the at least two gradient end stops individually, when controlling the plurality of LED light sources. Each of the respective color points defines dominant peak wavelength different from each other. Alternatively, each of the gradient end stop may alternative be defined by each respective CCT different from each other. The gradient light scene defines different color points for controlling the plurality of LED light sources during use, such that the plurality of LED light sources provides a first illumination at a predefined distance. The controller is configured to vary the color points along the linear light source array or part of the linear light source array.

The controller is configured to vary each of the at least two gradient end stops relative to each other, such that during use (i) the CCT of the (perceived) illumination at the predefined distance is kept constant, or (ii) the CCT of the (perceived) illumination at the predefined distance increases or decreases.

The controller is configured to vary each of the at least two gradient end stops relative to each other, such that the plurality of LED light sources provides a gradient light scene. The controller is configured to control the plurality of LED light sources, such that the CCT of the (perceived) illumination at the predefined distance is kept constant, even though the gradient end stops vary relative to each. Alternatively, the controller is configured to control the plurality of LED light sources such that the CCT of the (perceived) illumination at the predefined distance increases or decreases, based on the variation of the gradient end stops relative to each. The relation between the gradient end stops defines the color points. The color points can be controlled, when varying the gradient end stops relative to each other.

In an embodiment the controller is configured to control the plurality of LED light sources, wherein the plurality of LED light sources is configured to vary the light emitting from the plurality of LED light, such that each of the at least two gradient end stops are varied relative to each other, such that a correlation between the respective color points provides an intermediate gradient stop, wherein the intermediate gradient stop is moving along the BBL or the intermediate gradient stop is kept constant during use.

The controller may be configured to control the plurality of LED light sources, wherein the plurality of LED light sources is configured to vary the light emitting from the plurality of LED light, such that each of the at least two gradient end stops are varied relative to each other. The controller may be configured to vary each of the at least two gradient end stops relative to each other, such that the correlation between the respective color points of the at least two gradient end stops provide an intermediate gradient stop color point, when controlling the plurality of LED light sources. The intermediate gradient stop may be kept constant, such that during use the CCT of the (perceived) illumination at the predefined distance is kept constant.

Alternatively, the controller may be configured to vary each of the at least two gradient end stops relative to each other, such that the correlation between the respective color points provides an intermediate gradient stop when controlling the plurality of LED light sources. The color point may be moved along the BBL during use. The controller may be configured to vary each of the at least two gradient end stop at substantially the same time relative to each other, when controlling the plurality of LED light sources as such. The color point can be controlled such that the color point is located along the BBL during use. The color point is following along the BBL when the CCT of a (perceived) illumination at the predefined distance increases or decreases during transitioning.

In an embodiment the controller is configured to vary a luminous flux from at least two LED light sources of the plurality of LED light sources, such that during use the controller increases or decreases said total luminous flux, while keeping said total color temperature constant, such that a far field CCT as perceived in a far field is kept constant during use.

The controller is configured to vary the luminous flux from each of the plurality of LED light sources when controlling the plurality of LED light sources. During use the controller increases or decreases a total luminous flux from the plurality of LED light sources. The intermediate gradient stop is kept in a constant position relative to the BBL while increasing or decreasing a total luminous flux from each of the LED light sources, such that the plurality of LED light sources provides the (perceived) illumination at a predefined distance. The (perceived) illumination at a predefined distance may be increases or decreases, when increasing or decreasing a total luminous flux of the plurality of LED light sources in the linear light source array.

In an embodiment the controller is configured to vary the CCT in at least one transitioning step, such that the difference between a first gradient light scene and a second gradient light scene is the variation of the CCT relative to the at least one transitioning step.

The CCT may preferably be varied using at least one transitioning step. The difference between a first gradient light scene and a second gradient light scene is the variation of the CCT relative to the at least one transitioning step. The variation may relate to the transitioning between a first CCT and a second CCT may be one or more transitioning steps. The controller may be configured to vary the transitioning step with for example at least 500 K for every step, when the CCT of the (perceived) illumination at the predefined distance may be increased or decreased, when transition from the first gradient light scene to the second gradient light or vice versa. The steps may be a predetermined value. The transition may alternatively be substantially stepless.

In an embodiment each LED light source of the plurality of LED light sources comprise at least one first LED die configured to emit a first light having a first dominant peak wavelength in a red wavelength range, and at least one second LED die configured to emit a second dominant peak wavelength of green wavelength range, and at least one third LED die configured to emit a dominant peak wavelength of blue wavelength range, such that said controller is configured to control said luminous flux from each of the first, second and third LED die in a LED light source (21-26), and a correlation of the respective contributions of the first, second and third light defines a color point emitting from the LED light source (21-26). Wherein the color point is moving along an outer boundary of a spectral locus.

Each LED light source in the linear light source array may comprise one or more LED dies. At least one first LED die may be configured to emit a red wavelength range having a dominant peak wavelength of reddish light, for example a wavelength range within 625 nm-750 nm having a dominant. At least one second LED die may be configured to emit a green wavelength range having a dominant peak wavelength of greenish light, for example a wavelength range within 500 nm-565 nm having a dominant peak wavelength. At least one third LED die configured to emit a blue wavelength range having a dominant peak wavelength of blueish light, for example a wavelength range within 450 nm-485 nm having a dominant peak wavelength. Further LED dies may be configured to emit one or more wavelength ranges having dominant peak wavelengths, different than the first, second and third LED die having wavelength range with dominant peak wavelength. A spectral width of LEDs may be in the order of 20 nm to 50 nm. A color point may be defined by a dominant peak wavelength provided by an LED light source. An intermediated color point may be defined by the contribution of two or more dominant peak wavelengths provided by two or more LED light sources. The controller is configured to control the CCT of the (perceived) illumination at the predefined distance during use, when transition from the first gradient light scene to the second gradient light scene or vice versa.

In an embodiment, wherein each LED light source of the plurality of LED light sources comprises at least one fourth LED die configured to emit a fourth white light having a fourth CCT, and at least one fifth LED die configured to emit a fifth white light having a fifth CCT different from said fourth CCT different from said fourth CCT, such that said controller is configured to control said CCT of said (perceived) illumination at said predefined distance by varying the respective contribution of the fourth and fifth light.

The LED light source in the linear light source array may each comprise one or more LED dies in the LED light source. At least one fourth LED die may be configured to emit a fourth white light having a fourth CCT. At least one fifth LED die may be configured to emit a fifth white light having a fifth CCT. The fourth CCT of the fourth white light and the fifth CCT of the fifth white light may be correlated, such that the CCT of the (perceived) illumination is a correlation between the fourth CCT and fifth CCT determined by each of the respective contributions. The controller is configured to control the CCT of the (perceived) illumination at the predefined distance during use, when transition from the first gradient light scene to the second gradient light scene or vice versa.

The controller is configured to control each one of said LED light sources or each group of LED light sources in said linear light source array, such that the light emitting from each one of said LED light sources or each group of said LED light sources is varied in a plurality of gradient steps between a first CCT and a second CCT along the BBL. The controller is configured to control each one of the LED light sources in a plurality of gradient steps. The gradient steps may vary between a first CCT and a second CCT. The first CCT may be less than 2000 K. The second CCT may be more than 3000 K. the gradient step may for example step up and down with in the span of 1500 K to 12000 K. The first CCT may relate to warm white color temperature and a second CCT may relate to cold white color temperature. The gradient steps may follow along a BBL between warm white color temperature and cold white color temperature.

In an embodiment the linear light source array comprises a first end and a second end opposite the first end, where the controller is configured to control each of the plurality of LED light sources or section of the plurality of LED light sources, such that during use the light emitting from the first end provides a different perceived illumination at a predefined distance than the light emitting from the second end.

The linear light source array may comprise a first end and a second end. The second end is opposite the first end. The linear light source array may be a part of a plurality of linear light source arrays. The controller is configured to control each of the plurality of LED light sources or section of the plurality of LED light sources related to the linear light source array or linear light source arrays. During use the light that emits from the first end may provide a different (perceived) illumination at a predefined distance than the light which emits from the second end. Alternatively, the first end may emit light providing a similar (perceived) illumination at a predefined distance as the light which emits from the second end. A middle part between a first end and a second end, may emit light having a different CCT than different than the light which emits from the first and second end.

The controller is configured to keep an illumination on an illuminated surface the same or at least within a threshold. Different color points can be selected for each of the gradient light scenes, but due to the mixing of these colors on a surface, the illumination may be substantially the same if so chosen. An improvement in the decorative lighting effect and light quality is achieved when using a controller and a controllable linear light source array, such that a user's perception of the lighting at the predefined distance on an illuminated surface is enhanced by using a controlled lighting effect as an accompaniment for a multimedia device or similar.

A further aspect of the invention is a lighting system comprising the controller according to any one of the preceding claims and one or more luminaires, each luminaire of the one or more luminaires comprises linear light source array.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIGS. 1a and 1b illustrates a controllable transition from a first gradient light scene to a second gradient light scene relative to a CIE color spaces as well as a controller according to the invention.

FIG. 2 illustrates a controllable CCT in a CIE color spaces.

FIG. 3 illustrates an exemplary linear light source array which the controller according to the invention is configured to control.

Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

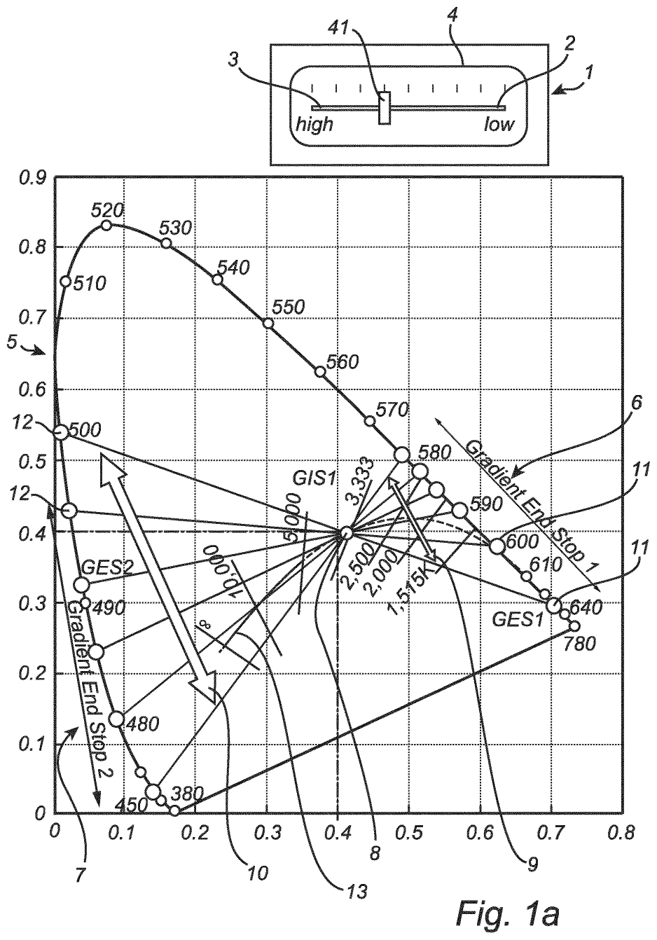

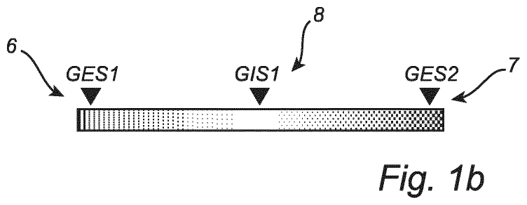

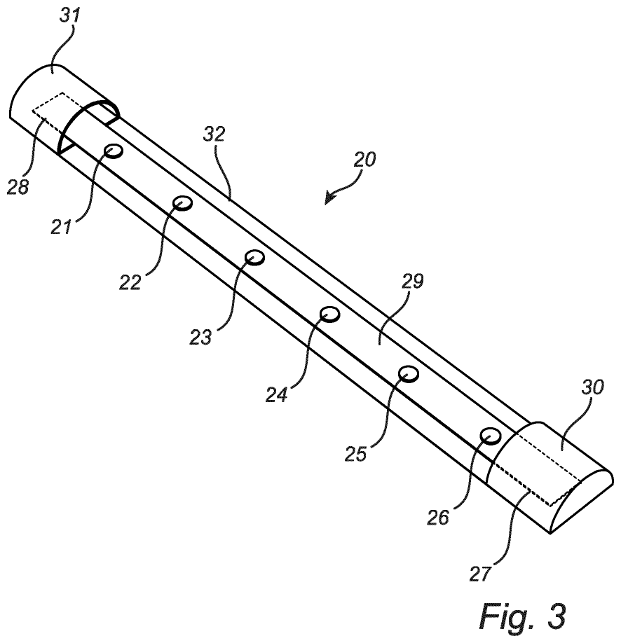

FIGS. 1a and 1b illustrates a controllable transition from a first gradient light scene to a second gradient light scene relative to a CIE color space 5. A controller 1 is shown schematically as an insert on FIGS. 1a and 1b. The controller 1 is configured to control a plurality of LED light sources 21-26 in a linear light source array 20, as illustrated in FIG. 3. The controller 1 is configured to control the settings of a plurality of color points the plurality by driving each of the LED light sources 21-26 separately in the linear light source array 20. In this example a first and a second gradient end stop, GES1 6 and GES2 7 refers to a first second gradient end stop color point 11 and a second gradient end stop color point 12, which are placed on opposite sides of the outer boundary of the CIE color space 5. When altering the gradient end stop color points 11,12 the controller 1 is configured to vary each gradient end stop color point 11,12 along the respective gradient end stop 6,7, at the outer boundary of the CIE color space 5, relatively to each other, such that a correlation between the respective color points 11,12 provides an intermediate gradient stop, GIS1 8. The GIS1 8 is defined by the gradient end stop color points 11,12 related to the first and the second gradient end stop, GES1 6 and GES2 7 and the respective contribution relative to each other. The intermediated gradient stop is kept at a constant CCT or the CCT may be varied.

The controller 1 is configured to receive an input indicative of a user selection of the first gradient light scene, which may comprise a sequence of at least five different light color points, wherein the color points may refer to the color points of the first and the second gradient end stop color points, GES1 6 and GES2 7 and/or the color point of the intermediate gradient stop color point, GIS1 8 or a combination thereof. The user may use a user interface 4, where the user can choose a first gradient light scene. The gradient light scene may be chosen to be a white light, which follows the Black Body Locus, BBL, 13 illustrated on FIG. 1 as a dotted line in a CIE 1931 color space 5. The correlated color temperature, CCT, may be varied along the BBL 13, such that a CCT of a (perceived) illumination at the predefined distance increases or decreases.

The gradient light scene may be chosen to be a white light having a constant CCT, moving away from the BBL 13, such that a CCT of a (perceived) illumination at the predefined distance is kept constant. A white light having a first CCT 2 may relate to warm white color temperature and a white light having a second CCT 3 may relate to cold white color temperature. The user may set the first gradient light scene by varying the position of a sliding contact 41, illustrated as a sliding contact in a potentiometer. Alternatively, a user interface 4 related to a smart phone or similar user interfaces may be employed.

The user may choose a first gradient light scene having a CCT between warm white and cold white. The controller 1 controls the plurality of LED light sources 21-26 according to a first gradient light scene. The first gradient light scene may be defined by different first color points 11, 12, wherein a correlation of the respective contributions of the first color points 11, 12 provides an intermediated gradient stop CIS1 color point 8. In such way the plurality of LED light sources 21-26 provides a first gradient end stop, GES1 6 comprising color points 11 having one or more dominant peak wavelengths, wherein the dominant peak wavelength of a specific color point may be varied along first gradient end stop, GES1 6, and thereby varying intermediated gradient stop GIS1 color point 8. The plurality of LED light sources 21-26 provides a second gradient end stop 7 comprising color points 12 having one or more dominant peak wavelengths. First color points 11 are provided by at least one first gradient end stop 6. Second color points 12 are provided by at least one second gradient stop 7. The lines between the first gradient end stop 6 and the second gradient stop 7 provides the GIS color point 8 located between the first gradient end stop 6 and the second gradient stop 7. In the example shown on FIGS. 1a and 1b, the GIS color point 8 is located on the BBL 13. The first gradient light scene is defined by different first color points for the plurality of LED light sources during use. The plurality of LED light sources 21-26 having a first gradient light scene setting provides a first illumination at a predefined distance from where the linear light source array 20 is placed.

The controller 1 controls the plurality of LED light sources 21-26 according to a second gradient light scene different to the first gradient light scene. The second gradient light scene may also be chosen by the user. Alternative the second gradient light scene may be chosen by a predetermined lighting sequence. The first gradient light scene and the second gradient light scene may be part of a dynamic gradient light scene. The dynamic gradient light scene may change according to the predetermined lighting sequence. The second gradient light scene may comprise a sequence of at least five different light color points. The color points refers to the color points of the first and the second gradient end stop, GES1 6 and GES2 7 and/or the color point of the intermediate gradient stop, GIS1 8 or a combination thereof, wherein at least one color point is different to the sequence of the first gradient light scene. The user may use a user interface 4, where the user can choose a second gradient light scene. The gradient light scene may be chosen to be a white light changing CCT, which follows the Black Body Locus, BBL, 13 illustrated on FIG. 1a as a dotted line in a CIE 1931 color space 5. The correlated color temperature, CCT, may be varied along the BBL 13, such that a CCT of a (perceived) illumination at the predefined distance increases or decreases.

The second gradient light scene may define a second color points 12 for the plurality of LED light sources 21-26 during use. The second color points 12 are different from the first color points 11. The controller 1 is configured to select the setting for the second gradient light scene. The controller 1 varies the plurality of LED light sources 21-26 from having a first gradient light scene setting to the second gradient light scene setting through a first transitioning from the first gradient light scene to the second gradient light scene. The LED light sources 21-26 provides thereafter a second illumination at the predefined distance from where the linear light source array 20 is placed.

The controller 1 may further control the plurality of light sources 21-26 by transitioning from the second gradient light scene back to the first light scene. During the transition from the second gradient light scene to the first gradient light scene, the CCT of a (perceived) illumination at the predefined distance is kept constant. Alternatively, during the transition from the second gradient light scene to the first gradient light scene the CCT of the (perceived) illumination at the predefined distance increases or decreases. The reversed transition may depend on the setting of the first light scene before the first transition. The controller 1 is configured to vary the CCT in at least one transitioning step. The controller 1 may in the transitioning step vary the CCT with at least 500 K. Alternatively, the steps may be a variation by a predetermined value or even substantially stepless.

The color points 11, 12 are defining at least two gradient end stops 6, 7. Each of the gradient end stops 6, 7 are defined by each respective color points 11, 12 having respective dominant peak wavelengths different from each other, which is illustrated along the outer boundary of the spectral locus of the CIE 1931 color spaces 5 in FIG. 1a. The dominant peak wavelength is illustrated as color points 11,12 along the outer boundary of the spectral locus, wherein the wavelength extends from 360 nm to 780 nm. The first end stop 6 may be varied between approximately 578 nm to 620 nm, illustrated with the arrow 9. The second end stop 7 may be varied between approximately 450 nm to 500 nm, illustrated by the arrow 10 in FIG. 1a. The controller 1 is configured to vary each of the at least two gradient end stops 6,7 separately, when controlling the plurality of LED light sources 21-26. The GIS color point 8 is a correlation of the color points. The controller 1 varies each of the at least two gradient end stops 6 and 7 relatives to each other, where the GIS color point 8 change position, such that the CCT of the (perceived) illumination at the predefined distance is kept constant, even if the GIS color point 8 is crossing the BBL 13 during use. Alternatively, the controller 1 varies each of the at least two gradient end stop 6 and 7 relative to each other, such that the GIS color point 8 is at or on the BBL 13 during use. The GIS color point 8 may change position along the BBL 13, such that the CCT of the (perceived) illumination at the predefined distance are increased or decreased.

The controller 1 is configured to vary the luminous flux from each of the plurality of LED light sources 21-26, such that during use the controller 1 increases or decreases a total luminous flux. The controller 1 is configured to control the light emitted from the LED light sources 21-26, such that the total CCT is kept constant.

The LED light source array 20, which is illustrated in FIG. 3, may comprise one or more LED dies or LED light sources 21-26. A first LED die can emit a dominant peak wavelength of red or reddish light. A second LED die can emit a dominant peak wavelength of green or greenish light. A third LED die can emit a dominant peak wavelength of blue or bluish light, such that said controller 1 during use controls said CCT of the (perceived) illumination at said predefined distance during the first transitioning from the first gradient light scene to the second gradient light scene.

The LED light source array 20, which is illustrated in FIG. 3, may comprise a first LED die configured to emit a first white light having a first CCT. The LED light source may also comprise a second LED die configured to emit a second white light having a second CCT. The first CCT comprises a first intermediate gradient stop and the second CCT comprises a second intermediate gradient stop. The controller 1 controls the CCT 14 of said (perceived) illumination at said predefined distance during the first transitioning from the first gradient light scene to the second gradient light scene, based on the first and the second intermediate gradient stop, wherein the CCT may be varied from a CCT1 to a CCT2.

The array light from the linear light source array 20 or part of the from the linear light source array 20 can be controlled, such that when the CCT 14 of said (perceived) illumination at the predefined distance increases or decreases, the CCT 14 of said (perceived) illumination at the predefined distance follows the Black Body Locus, BBL 13 from a first correlated color temperature CCT1 to a second correlated color temperature CCT2, wherein a gradient step between CCT1 and CCT2 is equal to or more than a predefined gradient step.

The array light from the linear light source array 20 is configured to be controlled such that plurality of LED light sources 21-26 arranged on the linear light source array 20 increase the total luminous flux of the array light, when the CCT 14 of the (perceived) illumination at the predefined distance increases. The array light from the linear light source array 20 is configured to be controlled such that plurality of LED light sources arranged on the linear light source array decrease the total luminous flux of the array light, when the CCT 14 of the (perceived) illumination at the predefined distance decreases.

The plurality of LED light sources 21-26 may be configured to be controlled such according to the first gradient light scene. The first gradient light scene may be defined by a sequence of a predetermined numbers of light color points, such that the color points have respective CCTs. The CCT of each of the color points related to the first gradient light scene increases from a first color point CCT1 of the sequence to a last color point CCTN, not shown in the FIGS. 1-3, of the sequence. The differences in CCT between adjacent color points may be predetermined, for example at least 300K.

The controller 1 may configured to control the plurality of LED light sources 21-26 according to a predetermined second gradient light scene. The second gradient light scene defines that at least one of the predetermined color points CCT are increased relative to the first gradient light scene, such that the correlated color temperature, CCT 14 of the (perceived) illumination at the predefined distance is increased. The second gradient light scene defines that at least one of the predetermined light color points CCT are decreased, such that the correlated color temperature, CCT 14 of a (perceived) illumination at the predefined distance is increased.

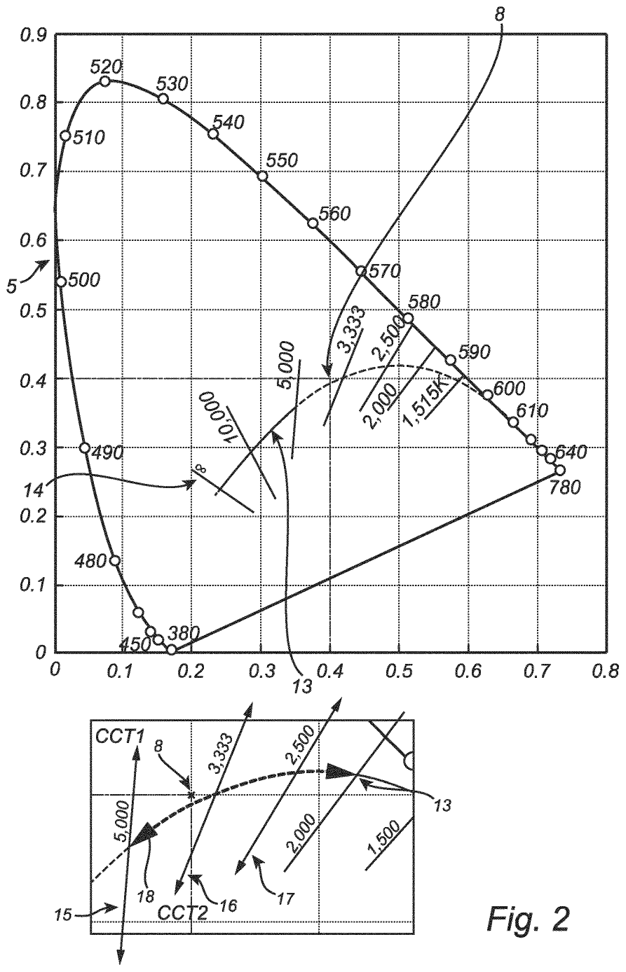

FIG. 2 illustrates a controllable CCT in a CIE color space 5. The GIS color point 8 is a correlation of other color points. The CCT lines 14 crossing the BBL 13 is referred to in degree of Kelvin.

The controller 1 is configured to control the linear light source array 20, such that the CCT 14 of a (perceived) illumination at the predefined distance on an illuminated surface is kept constant. The (perceived) illumination at the predefined distance on the surrounding surface is kept constant when GIS color point 8 is brought to change position along a CCT line, such as a predetermined CCT line 15 at 5000K, a predetermined CCT line 16 at 3333 K, or a predetermined CCT line 17 at 2500 K. The GIS color point 8 may follow a predefined CCT line through a first transitioning from the first gradient light scene to the second gradient light scene, while keeping the predefined CCT 14 constant.

The controller 1 is furthermore configured to control the linear light source array, such that the CCT 14 of a (perceived) illumination at the predefined distance increases or decreases on an illuminated surface or surfaces. The GIS color point 8 change position, such that the CCT 14 of the (perceived) illumination at the predefined distance is increased or decreased along the BBL 13, during use, which is illustrated with the arrow 18 following the BBL 13 in FIG. 2. The controller 1 varies each of the at least two gradient end stops relative to each other, such that the GIS color point 8 is moving on or along the BBL 13 during use. The GIS color point 8 change position, such that the CCT 14 of the (perceived) illumination at the predefined distance on an illuminated surface is increased or decreased during transition from the first gradient light scene to the second gradient light scene, and vice versa.

FIG. 3 illustrates schematically a linear light source array 20 to be controlled by a controller 1 according to the invention. The linear light source array 20 comprises a plurality of light sources 21-26. The plurality of light sources 21-26 are arranged on a substrate 29. The substrate 29 may be a PCB. The linear light source array 20, and more particularly the substrate 29, further comprises a first end 27 and a second end 28. The first end 27 is opposite to the second end 28.

The linear light source array 20 may be arranged in a tubular enclosure, such as to form a tubular light emitting device, or in another type of enclosure 32 to form another, differently shaped, light emitting device. The enclosure 32 may be provided with a first end cap 30 and an opposite second end cap 31. The end caps 30 and 31 enclose the first and second ends 27, 28, respectively. At least one of the end caps 30 and 31 may comprise an electrical connection (not shown) for connecting the linear light source array 20, and thus the plurality of LED light source 21-26, to a power source, such as mains.

Each LED light source of the plurality of LED light sources 21-26 comprises at least one LED die. A first LED die may be configured to emit a first light having a first dominant peak wavelength in a red wavelength range. A second LED die may be configured to emit second light having a second dominant peak wavelength in a green wavelength range. A third LED die may be configured to emit a third light having a third dominant peak wavelength in a blue wavelength range. The controller controls the luminous flux from each of the first, second and third LED die in each one of the LED light sources or a plurality of first, second and third LED die in the LED light sources 21-26. The color points may be varied along part of the outer boundary of the spectral locus. When correlating the respective contributions of the first, second and third light, the correlated light may provide an intermediated color point 8 emitting from the LED light source.

Each LED light source of the plurality of LED light sources may comprise a fourth LED die and a fifth LED die. The fourth LED die may be configured to emit a fourth light having a white light with a fourth CCT 14. The fifth LED die may be configured to emit a fifth light having a white light with a fifth CCT 14, wherein the fifth CCT is different from the fourth CCT. The controller 1 controls the correlated CCT of the (perceived) illumination at a predefined distance by varying the respective contribution of the fourth and fifth light.

The controller is configured to vary a luminous flux from at least two LED light sources 21,26 of the plurality of LED light sources 21-26, such that the controller increases or decreases the total luminous flux. The total color temperature 14 may be substantially constant at the first and second end cap 30,31 of the linear light source array 20, such that a far field CCT as perceived in a far field of the illumination at the predefined distance is kept substantially constant, when increasing or decreasing the total luminous flux from the plurality of LED light sources 21-26.

The linear light source array 20 comprises a first end 27 covered by the first end cap 30, and a second end 28 opposite the first end 27 covered by the second end cap 31. The controller 1 controls the light emitting from each of the plurality of LED light sources 21-26. During use the light, which emits from the first end 27 provides a different (perceived) illumination at the predefined distance than the light emitting from the second end 28.

1. A controller for controlling a linear light source array wherein the linear light source array comprises a plurality of LED light sources configured to, in operation and in combination, provide an array light having a total luminous flux providing illumination at a predefined distance, wherein the controller is configured to control the plurality of LED light sources according to:
a first gradient light scene, wherein the first gradient light scene defines at least five first color points different from each other, such that the plurality of LED light sources provides a first illumination at the predefined distance,
a first transitioning from the first gradient light scene to a second gradient light scene different from the first gradient light scene, wherein the second gradient light scene defines at least five second color points different from each other, wherein at least one of the at least five second color points are different than at least one of the at least five first color points, such that the plurality of LED light sources provides a second illumination at the predefined distance, wherein the controller is configured to select the second gradient light scene, such that during the first transitioning from the first gradient light scene to the second gradient light scene, a correlated color temperature, CCT, of said illumination at the predefined distance is kept constant.

2. Controller according to claim 1, wherein said controller is configured to control the plurality of LED light sources according to the first gradient light scene, wherein the first gradient light scene comprises a sequence of at least five different light color points, such that the at least five different color points have respective CCTs, which increases from a first color point of the sequence to a last color point of the sequence.

3. Controller according to claim 1, wherein said controller is configured to control the plurality of LED light sources, wherein:
(i) one or more of the plurality of LED light sources are arranged at a first end of the linear light source array, wherein the one or more of the plurality of LED light sources are configured to correspond to one or more color points, with the highest CCT compared to the one or more of the plurality of LED light sources, which are arranged at the first end of the linear light source array, when dimmed down or switched off, and/or
(ii) one or more of the plurality of LED light sources are arranged at a second end of the linear light source array, wherein the one or more of the plurality of LED light sources are configured to correspond to one or more color points with the lowest CCT compared to the one or more of the plurality of LED light sources, which are arranged at the second end of the linear light source array, when dimmed down or switched off.

4. Controller according to claim 1, wherein the controller is further configured to control the plurality of LED light sources, such that during a second transitioning from the second gradient light scene to the first gradient light scene and/or during a third transitioning from the second gradient light scene to a third gradient light scene different from said second gradient light scene, the CCT of the illumination at the predefined distance is kept constant.

5. Controller according to claim 1, wherein at least two gradient end stops are defined by selected color points, wherein each of said selected color points represent a respective dominant peak wavelength different from a remaining respective dominant peak wavelength, wherein the controller is configured to vary each of the at least two gradient end stops independently when varying the selected color points.

6. Controller according to claim 5, wherein the controller is configured to vary each of the at least two gradient end stop relative to each other, such that a correlation between the respective color points provides an intermediate gradient stop, wherein the intermediated gradient stop is kept constant.

7. Controller according to claim 1, wherein said controller is configured to vary the luminous flux from at least two LED light sources of said plurality of LED light sources, such that the controller increases or decreases said total luminous flux, such that a far field CCT as perceived in a far field is kept constant.

8. Controller according to claim 1, wherein each LED light source of the plurality of LED light sources comprises at least one first LED die configured to emit a first light having a first dominant peak wavelength in a red wavelength range, and at least one second LED die configured to emit second light having a second dominant peak wavelength in a green wavelength range, and at least one third LED die configured to emit a third light having a third dominant peak wavelength in a blue wavelength range, such that said controller is capable of controlling said luminous flux from each of the first, second and third LED die in a LED light source, and a correlation of the respective contributions of the first, second and third light defines a color point emitting from the LED light source, wherein the color point is moving along an outer boundary of a spectral locus.

9. Controller according to claim 1, wherein each LED light source of the plurality of LED light sources comprises at least one fourth LED die configured to emit a fourth light having a fourth CCT, and at least one fifth LED die configured to emit a fifth light having a fifth CCT different from said fourth CCT, such that said controller is capable of controlling said CCT of said illumination at said predefined distance by varying the respective contribution of the fourth and fifth light.

10. Controller according to claim 1, wherein said linear light source array comprises a first end and a second end opposite the first end, wherein the controller is configured to control the light emitting from each of said plurality of LED light sources or section of said plurality of LED light sources, such that during use the light emitting from the first end provides a different illumination at said predefined distance than the light emitting from the second end.

11. A lighting system comprising the controller according to claim 1 and one or more luminaires, each luminaire of the one or more luminaires comprises a linear light source array.
